(19) United States
(12) Patent Application Publication
(10) Pub. No.: US 2002/0157113 A1
(43) Pub. Date: Oct. 24, 2002

(54) System and method for retrieving and storing multimedia data

(76) Inventor: Fred Allegrezza, Hatfield, PA (US)

Correspondence Address: NEEDLE & ROSENBERG P C, 127 PEACHTREE STREET N E, ATLANTA, GA, 30303-1811, US

(21) Appl. No.: 09/839,581

(22) Filed: Apr. 20, 2001

(51) Int. Cl. H04N 7/173; G06F 12/00; G06F 12/14; G06F 12/16; G06F 13/00; G06F 13/28; H04N 7/16

(52) U.S. Cl. 725/115; 725/92; 725/98; 725/117; 725/145; 711/114; 711/100

(57) ABSTRACT

Requests are received for retrieving and storing data from and to a plurality of storage devices. A processor is designated for handling each request, based, e.g., on the load of each processor. A request for retrieving data is forwarded directly from the designated processor to the storage device via a switch. Responses from the storage devices are routed directly to the designated processor via the switch. The switch independently routes the request for retrieving data and the responses between the storage devices and the processor, based on directory information obtained by the processor. Data provided by a designated processor is stored on the storage devices via a switch. The switch independently routes the data to be stored directly from the designated processor to the storage devices, based on directory information created by the processor. Requests and responses are exchanged between the switch and the storage devices via at least one high speed network connected to the storage devices.

### BACKGROUND OF THE INVENTION

The present invention is directed to a method and system for retrieving and storing data. More particularly, the present invention is directed to a method and system for retrieving and storing multimedia data on a plurality of storage devices.

Video on demand servers are used to stream digital video through a network from a storage device, e.g., a disk array, to a user or client. Ideally, a video server provides a large number of concurrent streams to a number of clients while maintaining a constant or variable bit rate stream so as to provide a smooth and continuous video presentation. A video on demand streaming server should be capable of starting and stopping streams within one or two seconds of a command from a user or client device and should also be capable of presenting a fast forward mode and a rewind mode for the streamed video to emulate the operation of a traditional consumer video cassette recorder (VCR).

Various attempts have been made in the past to provide video on demand. These attempts have typically involved networking of multiple CPUs, each CPU connected to disk drives, memory and outputs. Streaming video data is typically required to pass through two or more CPUs before output to the distribution network. This results in a cumbersome arrangement and an inefficient consumption of resources and slows the response time.

There is thus a need for a system and method for supplying video on demand that consumes a minimal amount of resources and that provides a quick response time.

### SUMMARY OF THE INVENTION

The present invention is directed to a method and system for retrieving and storing multimedia data on a plurality of storage devices.

According to one embodiment, a system and method are provided for retrieving data, such as video stream data, stored on a plurality of storage devices, e.g., disk drives. A request for retrieving data, e.g., streaming video data, is received, and a processor is designated for handling the request. The processor then begins retrieving data, e.g., streaming video, by reading data from the storages devices through a storage area network containing a switch. The switch independently routes the request to the storage devices. The storage devices respond with the data, and the storage area network switch routes the data responses back to the requesting processor. The switch independently routes the request for retrieving data from the requesting processor and the responses from the storage devices, based on directory information obtained by the processor from the storage devices.

According to another embodiment, a method and system are provided for storing data on a plurality of storage devices. A request for storing data, e.g., video stream data, is received, and a processor is designated for handling the request. Data provided by the designated processor is stored on the storage devices via a switch. The switch independently routes the data to be stored directly from the designated processor to the storage devices, based on directory information created by the processor, e.g., based on the length and the amount of data to be stored.

According to exemplary embodiments, a processor is designated for handling requests for retrieving and storing data based, e.g., on the load of each processor. Data and requests and responses are exchanged between the switch and the storage devices via at least one high speed network connected to the storage devices. The switch may accommodate a plurality of high speed networks and connected storage devices The high speed network may be, e.g., a fiber channel network, a SCSI network, or an Ethernet network.

According to exemplary embodiments, data read from the storage devices is formatted for a delivery network. The data only needs to be handled by one processor for output to the delivery network.

The objects, advantages and features of the present invention will become more apparent when reference is made to the following description taken in conjunction with the accompanying drawings.

### BRIEF DESCRIPTION OF THE DRAWINGS

FIG. 1 illustrates a video on demand server architecture including a storage area network switch according to an exemplary embodiment;

FIG. 2A illustrates a method for retrieving data according to an exemplary embodiment;

FIG. 2B illustrates a method for storing data according to an exemplary embodiment;

FIG. 3A illustrates an exemplary directory structure;

FIG. 3B illustrates striping of video content and parity data across disk drives; and

FIGS. 4A-4C illustrate sequences of data blocks read from various disk drives according to an exemplary embodiment.

### DETAILED DESCRIPTION OF THE INVENTION

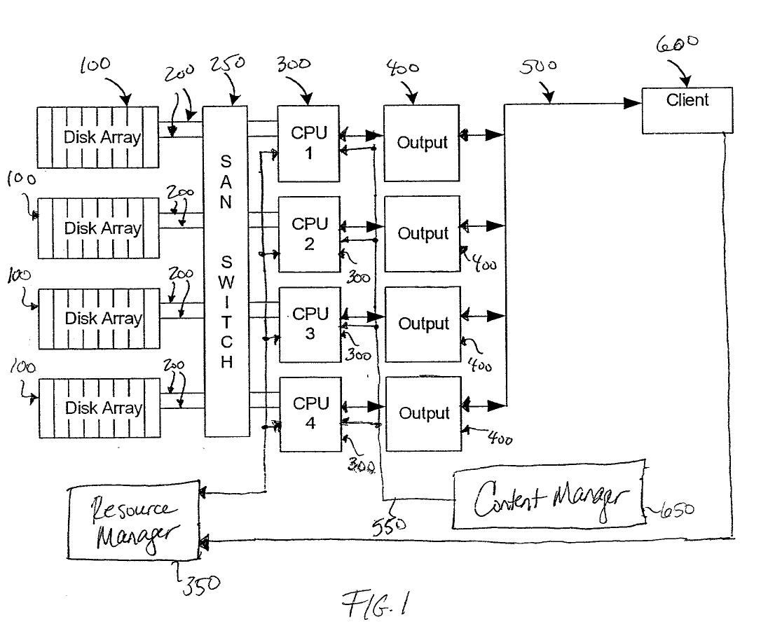

FIG. 1 illustrates a video on demand streaming server architecture including storage devices, e.g., arrays of magnetic disk drives 100, connected via a storage area network 200 to CPUs 300. The CPUs 300 are connected, in turn, to outputs 400 via, e.g., PCI buses. The outputs 400 are connected via a connection 500 to a client device 600. The CPUs 300 are also connected to a content manager 650 via a connection 550.

According to an exemplary embodiment, multiple storage area networks 200 can be joined using a Storage Area Network (SAN) 250, thus efficiently expanding the video storage network. The SAN switch 250 allows multiple CPUs to access multiple common storage devices, e.g., disk arrays 100. The SAN switch 250 is a self-learning switch that does not require workstation configuration. The SAN switch 250 routes data independently, using addresses provided by the designated CPU, based on the directory information.

The SAN switch 250 allows multiple storage area networks to be joined together, allowing each network to run at full speed. The SAN switch 250 routes or switches data between the networks, based on the addresses provided by the designated CPU.

A request from, e.g., a client device 600 to retrieve data is first received by a resource manager 350 that analyzes the loads of the CPUs and designates a CPU for handling the request, so that the load is balanced among the CPUs. The resource manager 350 keeps track of all assigned sessions to each CPU. In addition, the resource manager 350 contains a topology map identifying the CPU outputs that can be used to transmit to each client device. Thus, the resource manager 350 can then determine the least loaded processor having outputs that can transmit data to the requesting client device 600.

Data to be stored on the disk drives is loaded to the content manager 650 by inserting a tape of recorded data at the content manager 650, transmitting data via a satellite or Ethernet link to the content manager 650, etc. The content manager 650 designates a processor for storing the data and delivers the data to be stored via the connection 550. The connection 550 may be a high speed network, such as an Ethernet network. The CPU designated to store the video files on the storage system also creates a directory based on the data to be stored and stores directory information on the disk drives. The directory is created, e.g., by determining the amount of data to be written and determining the number of disks required to store the data. The directory specifies the number of disks that the data is distributed across. Then, the CPU addresses the disk drives via the SAN switch 250, accordingly, and the data and directory are distributed on the disk drives.

Assume, for example, that the data to be stored requires 48 disks. Then, the CPU indicates in the directory that the data spans across 48 disks, and the data is written across disks 1 to 48 via the SAN switch 250.

The directory allows the data to be retrieved across the multiple disk drives. All of the CPUs have access to the directory to allow access to the data stored on the disk drives. When data is stored on the disk drives by any of the CPUs, the directory is updated, accordingly. Multiple CPUs can store data on the disk drives as long as the updates to the directory and the location of storage blocks are interlocked with multiple CPUs, i.e., as long as the multiple CPUs have access to the directory.

According to an exemplary embodiment, the directory structure is stored on predetermined data blocks of the disk drives. Each directory block contains an array of data structures. Each data structure contains a file name, file attributes, such a file size, date modified, and a list of pointers or indexes to data blocks on the disk drives where the data is stored. Data blocks that are not assigned to a video file are assigned to a hidden file representing all of the free blocks.

As new files are added to the system, new directory entries are made, and the free blocks are removed from the free file and added to the new file. When files are deleted and blocks become free, these blocks are added to the free file.

When a video stream is requested by a client device 600, a CPU is designated to handle the request by the resource manager 350. The designated CPU has access to all of the disk drives and reads the directory information from the disk drives to identify where blocks of data are stored on the disk drives. The request is delivered to the CPU 300, and the CPU 300 sends the request for data, including the storage device address and the blocks of data to be read. The request message also includes the source CPU device address. The SAN switch 250 then independently routes the block read command to the designated storage device using the device address. The disk storage device 100 accesses the data internally and then returns the data blocks in one or more responses addressed to the original requesting CPU device address, formatted for the delivery network. The SAN switch 250 then independently routes the data block response to the designated CPU 300 using the device address.

The data retrieved from the disk drives is stored and processed within the CPU 300 to provide the necessary addressing information to be sent out via the output 400 to the delivery network 500 to be received by the client device 600. The client device 600 may also communicate with the CPU 300 via the delivery network 500 and the output 400, e.g., to pass a request for data once the CPU has been designated for handling the request and to instruct the CPU during video streaming, e.g., to pause, rewind, etc. The output 400 may be, e.g., a Quadrature Amplitude Modulated (QAM) board, an Asynchronous Transfer Mode (ATM) board, an Ethernet output board, etc. The delivery network 500 may be, e.g., an Ethernet network, an ATM network, a Moving Pictures Expert Group (MPEG) 2 Transport network, a QAM CATV network, a Digital Subscriber Loop (DSL) network, a Small Computer Systems Interface (SCSI) network, a Digital Video Broadcasting-Asynchronous Serial Interface (DVB-ASI) network, etc. The client device 600 may be, e.g., a cable settop box for QAM output, a DSL settop box for DSL output, or a PC for Ethernet output.

According to an exemplary embodiment, each CPU 300 can read and write data to the disk drives 100 using multiple high speed networks, e.g., fiber channel networks. A fiber channel network is a high speed (1 Gigabit) arbitrated loop communications network designed for high speed transfer of data blocks. Fiber channels allow for 128 devices to be connected on one loop. In FIG. 1, there are multiple fiber channel networks 200 connecting multiple sets of disk drives 100 to multiple CPUs 300.

The fiber channel network shown may be a full duplex arbitrated loop. The loop architecture allows each segment of the network to be very long, e.g., km, and can be implemented with fiber optics. Each segment of the loop is a point to point communications channel. Each device on the fiber channel loop receives data on one segment on the loop and retransmits the data to the next segment of the loop. Any data addressed to the drive is stored in its local memory. Data may be transmitted to and from the disk drives when the network is available For a fiber channel network, a typical SAN switch 250 can accommodate 32 networks. Each network can communicate at 1-2 Gb/sec rate. Each network may have 128 storage devices attached. The video server system can thus be expanded to 16 disk drive assemblies and 16 CPUs. The system storage capacity is the 2048 storage devices (16×128=2048 storage devices), and the system communication capability is then 32 Gb/sec.

An exemplary system may have 16 CPUs and 16 drive assemblies of 12 drives each, using fiber channel 200, giving a server capacity of 10,666 streams at 3.0 Mb/sec.

This architecture is not limited. Larger systems can be built using larger SAN switches and higher speed networks.

Although described above as a fiber channel network, the storage area network may also include a SCSI network, an Ethernet network, a Fiber Distributed Data Interface (FDDI) network, or another high speed communications network.

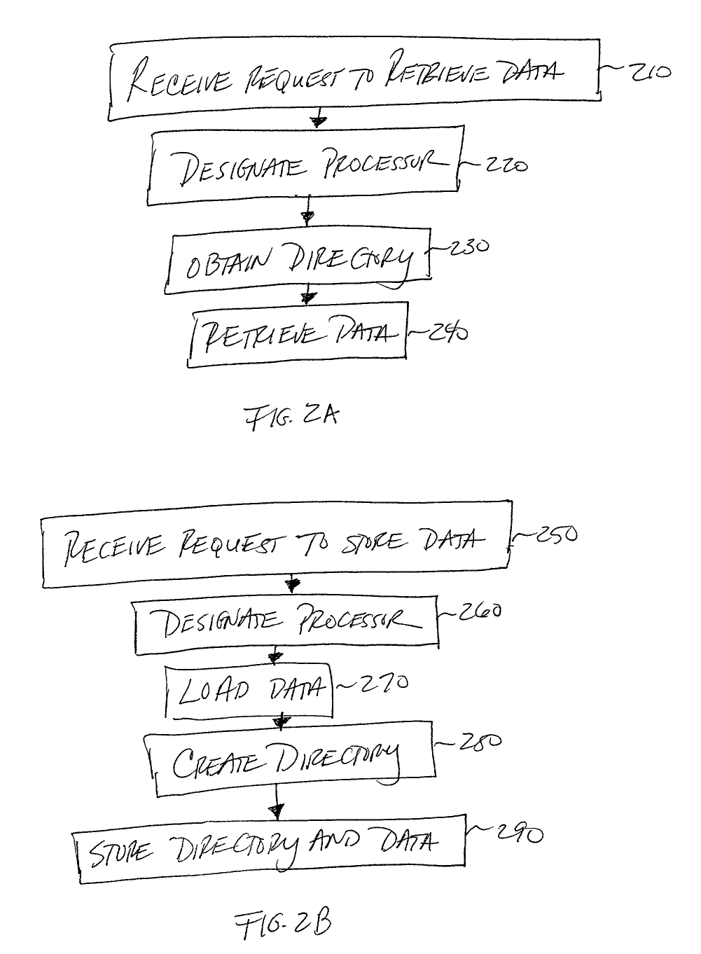

FIG. 2A illustrates a method for retrieving data from the storage devices according to an exemplary embodiment. The method begins at step 210 at which a request made by a client to retrieve data stored on the disk drives is received by the resource manager. At step 220, a processor is designated to handle the request. At step 230, the designated CPU obtains the directory from the disk drives via the SAN 250. The CPU then searches the directory structure to find the file requested. For example, the CPU searches the directory structure stored on predetermined blocks of the disk drives, starting with the first disk drive. At step 240, the CPU retrieves the data from the disk drives, via the SAN 250, based on the directory information.

FIG. 2B illustrates a method for storing data on storage devices according to an exemplary embodiment. The method beings at step 250 at which a request is received at the resource manager to store data. A CPU is designated at step 260 to store the data, and the data is loaded onto the CPU from the content manager 650 at step 270. At step 280, the CPU creates a directory based on the data to be stored, and at step 290, the CPU stores the directory and the data across the disk drives via the SAN switch.

The video on demand server architecture described above is particular suitably for storing/retrieving data using a Redundant Array of Inexpensive Disks (RAID) algorithm. According to this type of algorithm, data is striped across disk drives, e.g., each disk drive is partitioned into stripes, and the stripes are interleaved round-robin so that the combined storage space includes alternately stripes from each drive.

The designated CPUs in the system shown in FIG. 1 can store the video file and the directory across all the disk drives using a RAID striping algorithm. The designated CPU(s) sequentially store a block of data on each of the disk drives.

For example, using a strip size of 128 Kbytes, the designated CPU stores the first 128 K bytes of a video file on disk drive 1, the second 128 K bytes of the video file on drive 2, etc. After the number of disk drives is exhausted, the CPU then continues storing data on drive 1, drive 2, and so on, until the complete file is stored.

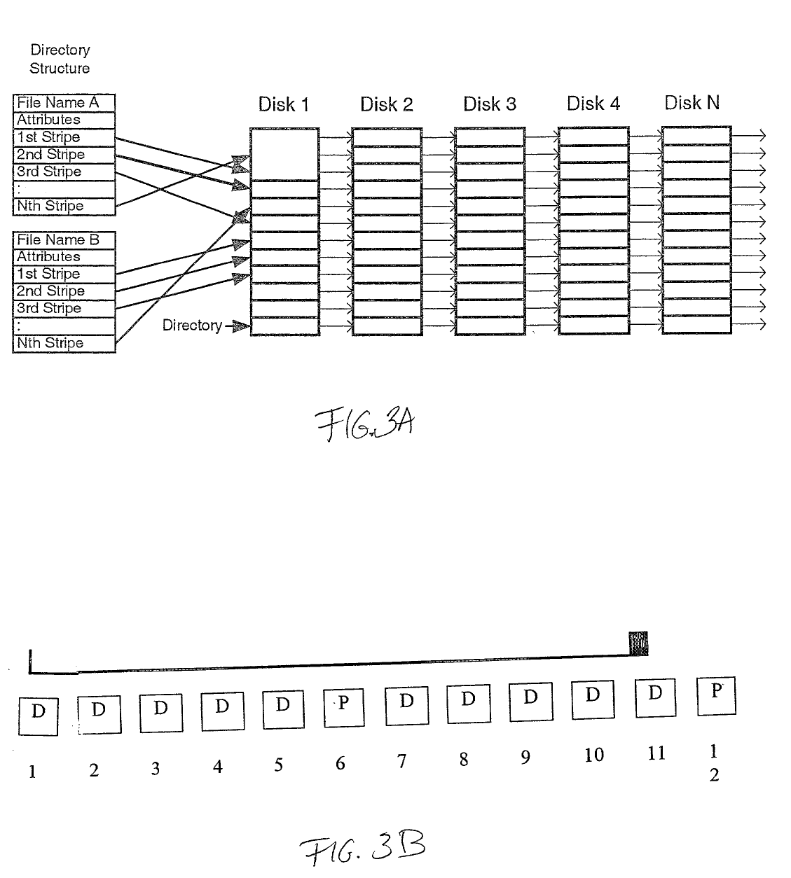

Striping the data across the disk drives simplifies the directory structure. FIG. 3A illustrates a directory structure for data striped across disk drives. Since the data is striped across the disk drives, the directory only needs to point to the beginning of the data stripe. The directory may also be striped across the disks drives.

There are different types of RAID algorithms, e.g., RAID 0, RAID 1, RAID 3, RAID 4, RAID 5, RAID 0+1, etc. These algorithms differ in the manner in which disk fault-tolerance is provided.

According to some RAID algorithms, e.g., RAID 5, fault tolerance is provided by creating a parity block at a defined interval to allow recreation of the data in the event of a driver read failure. The parity interval can be configured to any defined number and is not dependent on the number of disk drives. For example, the storage array may contain 64 disk drives, and the parity interval may be every 5^{th} drive. This example assures that the parity data is not always stored on the same drive. This, in turn, spreads the disk drive access loading evenly among the drives. The selection of the parity interval affects the amount of computation necessary to recreate the data when the data is read and the cost of the redundant storage. A shorter parity interval provides for lower computation and RAM memory requirements at the expense of higher cost of additional disk drives. The optimal selection can be configured in the computer system to allow for the best economic balance of the cost of storage versus the cost of computation and RAM memory.

FIG. 3B illustrates an example of data stored in a RAID 5 level format. In FIG. 3B, a set of 12 disk drives is represented, with drives 1 through 5 being data drives, drive 6 being a parity drive, drives 7-11 being data drives, and drive 12 being a parity drive.

For this example, in order to rebuild data efficiently, there need to be six buffers of memory in the CPU for reading data so that data can be recreated without an additional reading of drives when a failed drive is detected. At least one additional buffer is needed to allow time to recreate the data before it is needed to transmit. This makes a total of seven buffers. The CPU reads seven buffers of data when beginning data retrieval. All of these blocks are read into one CPU, with the SAN switch 250 switching from drive to drive.

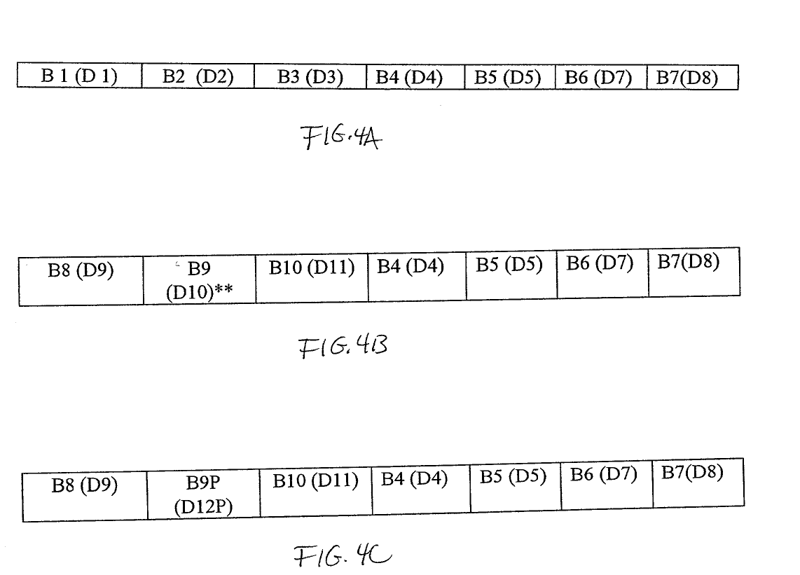

FIG. 4A illustrates the blocks as they are read from memory, where B represents a block, and D represents a drive. As can be seen from FIG. 4A, block 1 (B1) is read from drive 1 (D1), block 2 (B2) is read from drive 2 (D2) , . . . , and block 5 (B5) is read from drive 5 (D5). Since drive 6 (D6) is a parity drive, it is skipped. Block 6 is read from drive 7 (D7), and block 7 (B7) is read from drive 8 (D8).

The CPU continues reading data from the disk drives as the data is transmitted via the SAN switch 250. After B1 is transmitted, block 8 (B8) is read from disk 9 (D9) in its place. Then, if the reading of block 9 (B9) from disk 10 (D10) fails, this block is skipped over, and block 10 (B 10) is read from drive 11 (D11). This is shown in FIG. 4B.

Next, the CPU reads the parity block from drive 12 (D12) into the memory buffer for block 9 (B9), as shown in FIG. 4C.

At this point in time, the CPU has data from drives 7, 8, 9, 11, and 12 in memory. The CPU can now reconstruct the data for drive 10. After data is reconstructed, reading and transmitting may continue as normal.

The directory structure may also be stored in a RAID 5 fashion across the disk drives so that the failure of a single drive does not result in a lost directory structure.

Using this form of RAID allows the video server to use the full throughput capacity of the disk drives. When a disk drive fails, there is no impact on the number of reads from the other disk drives.

According to this RAID architecture, the content data can be striped across any number of drives, and the parity spacing may be independent of the total number of drives used in the striping. For example, there may be one parity drive for every three data drives. This reduces the amount of memory required and the amount of CPU time to reconstruct the data, since only three blocks are read to reconstruct the data.

Each time a new stream of data is to be retrieved or a transition to a fast forward mode or a rewind mode is made, the read ahead buffer must be filled. In order to reduce the latency, the CPU can read two buffers and start the delivery of data to the client. The additional buffers can be scheduled to read two at a time to “catch up” and fill queue. The worst scenario is when there is a failed drive in the first read sequence. In this case, all of the buffers need to be read to build the data before streaming the data.

In order to maximize efficiency from the system, the start of data retrieval may be scheduled to distribute the loading of any assigned drive. This works when all content is of the same constant data rate. It may also work with multiple constant bit rates if the strip size is related to the data rate such that the time sequence for reading drives is always the same.

According to exemplary embodiments, high capacity multimedia streaming is provided usign a storage area network switch. This enables a quick and efficient delivery of data.

It should be understood that the foregoing description and accompanying drawings are by example only. A variety of modifications are envisioned that do not depart from the scope and spirit of the invention. For example, although the examples above are directed to storage and retrieval of video data, the invention is also applicable to storage and retrieval of other types of data, e.g., audio data.

The above description is intended by way of example only and is not intended to limit the present invention in any way.

What is claimed is:

1. A system for retrieving data distributed across a plurality of storage devices, the system comprising:
a plurality of processors, wherein upon receipt of a request for retrieving data, a processor is designated for handling the request; and
a switch arranged between the processors and the storage devices, wherein the switch independently routes a request for retrieving data from the designated processor directly to the storage devices containing the requested data and independently routes responses from the storage devices directly to the designated processor.

2. The system of claim 1, further comprising a resource manager for designating a processor to handle a request, based on the load on each processor.

3. The system of claim 1, wherein the switch routes the request for retrieving data based on directory information obtained by the processor.

4. The system of claim 3, wherein the processor obtains the directory information from the storage devices.

5. The system of claim 1, further comprising at least one high speed network connected to the storage devices and arranged between the switch and the storage devices.

6. The system of claim 5, wherein the switch accommodates a plurality of high speed networks and connected storage devices.

7. The system of claim 5, wherein the high speed network is a fiber channel network, a Small Computer Systems Interface (SCSI) network, or an Ethernet network.

8. The system of claim 1, wherein the data is video stream data.

9. The system of claim 1, wherein the storage devices are disk drives.

10. The system of claim 9, wherein the data is stored in a Redundant Array of Inexpensive Disks (RAID) format among the disk drives.

11. The system of claim 1, further comprising a high speed network for delivering the retrieved data from the designated processor to a client device.

12. The system of claim 11, wherein the high speed network is an Ethernet network, an Asynchronous Transfer Mode (ATM) network, a Moving Pictures Expert Group (MPEG) 2 Transport network, a Quadrature Amplitude Modulated (QAM) cable television network, a Digital Subscriber Loop (DSL) network, a Small Computer Systems Interface (SCSI) network, or a Digital Video Broadcasting-Asynchronous Serial Interface (DVB-ASI) network.

13. A method for retrieving data distributed across a plurality of storage devices, the method comprising the steps of:
receiving a request for retrieving data;
designating a processor for handling the request;
forwarding the request directly from the designated processor to the storage devices containing the data via a switch; and
returning responses from the storage devices directly to the designated processor via the switch, wherein the switch independently routes the request for retrieving data and the responses between the storage devices and the processor.

14. The method of claim 13, wherein the step of designating a processor includes performing load balancing on the processors and designating a processor based on the load balancing.

15. The method of claim 13, wherein the switch routes the request for retrieving data based on directory information obtained by the processor.

16. The method of claim 14, wherein the processor obtains the directory information from the storage devices.

17. The method of claim 13, wherein the request is forwarded from the processor to the storage devices via at least one high speed network connected to the storage devices.

18. The method of claim 17, wherein the switch accommodates a plurality of high speed networks and connected storage devices.

19. The method of claim 17, wherein the high speed network is a fiber channel network, a Small Computer Systems Interface (SCSI) network, or an Ethernet network.

20. The method of claim 13, wherein the data is video stream data.

21. The method of claim 13, wherein the storage devices are disk drives.

22. The method of claim 21, wherein the data is stored in a Redundant Array of Inexpensive Disks (RAID) format among the disk drives.

23. The method of claim 13, further comprising delivering the retrieved data from the designated processor to a client device via a high speed network.

24. The method of claim 23, wherein the high speed network is an Ethernet network, an Asynchronous Transfer Mode (ATM) network, a Moving Pictures Expert Group (MPEG) 2 Transport network, a Quadrature Amplitude Modulated (QAM) cable television network, a Digital Subscriber Loop (DSL) network, a Small Computer Systems Interface (SCSI) network, or a Digital Video Broadcasting-Asynchronous Serial Interface (DVB-ASI) network.

25. A system for storing data across a plurality of storage devices, the system comprising:
a plurality of processors, wherein upon receipt of a request for storing data, a processor is designated for handling the request; and
a switch arranged between the processors and the storage devices, wherein the switch independently routes the data to be stored from the designated processor directly to the storage devices.

26. The system of claim 25, further comprising a content manager for loading data to be stored, designating a processor for handling the data storage, and forwarding the data to be stored to the designated processor.

27. The system of claim 25, wherein the switch routes the data to the storage devices based on directory information created by the processor.

28. The system of claim 27, wherein the processor creates the directory information depending on the length and amount of data to be stored on the storage devices.

29. The system of claim 25, further comprising at least one high speed network connected to the storage devices and arranged between the switch and the storage devices.

30. The system of claim 29, wherein the switch accommodates a plurality of high speed networks and connected storage devices.

31. The system of claim 29, wherein the high speed network is a fiber channel network, a Small Computer Systems Interface (SCSI) network, or an Ethernet network.

32. The system of claim 25, wherein the data is video stream data.

33. The system of claim 25, wherein the storage devices are disk drives.

34. The system of claim 33, wherein the data is stored in a Redundant Array of Inexpensive Disks (RAID) format among the disk drives.

35. The system of claim 26, further comprising a high speed network for forwarding the loaded data from the content manager to the designated processor.

36. The system of claim 35, wherein the high speed network is an Ethernet network.

37. A method for storing data across a plurality of storage devices, the method comprising the steps of:
receiving a request for storing data;
designating a processor for handling the request; and
storing data provided by the designated processor on the storage devices via a switch, wherein the switch independently routes the data to be stored directly from the designated processor to the storage devices.

38. The method of claim 37, further comprising loading data to be stored on a content manager that designates a processor for handling the data storage and forwarding the data to be stored to the designated processor.

39. The method of claim 37, wherein the switch routes the data to be stored based on directory information created by the processor.

40. The method of claim 39, wherein the processor creates the directory information depending on the length and the amount of data to be stored.

41. The method of claim 37, wherein the request is forwarded from the processor to the storage devices via at least one high speed network connected to the storage devices.

42. The method of claim 41, wherein the switch accommodates a plurality of high speed networks and connected storage devices.

43. The method of claim 41, wherein the high speed network is a fiber channel network, a Small Computer Systems Interface (SCSI) network, or an Ethernet network.

44. The method of claim 37, wherein the data is video stream data.

45. The method of claim 37, wherein the storage devices are disk drives.

46. The method of claim 45, wherein the data is stored in a Redundant Array of Inexpensive Disks (RAID) format among the disk drives.

47. The method of claim 38, wherein the loaded data is forwarded from the content manager to the designated processor via a high speed network.

48. The method of claim 47, wherein the high speed network is an Ethernet network.

49. A system for retrieving data distributed across a plurality of storage devices, the system comprising:
a plurality of processors, wherein upon receipt of a request for retrieving data, a processor is designated for handling the request; and
a switch arranged between the processors and the storage devices, wherein the switch independently routes a request for retrieving data from the designated processor directly to the storage devices containing the requested data, based on directory information obtained by the processor from the storage devices, and independently routes responses from the storage devices directly to the designated processor.

50. A method for retrieving data distributed across a plurality of storage devices, the method comprising the steps of:
receiving a request for retrieving data;
designating a processor for handling the request;
forwarding the request directly from the designated processor to the storage devices containing the data via a switch, wherein the switch independently routes the request for retrieving data to the storage devices based on directory information obtained by the processor from the storage devices; and
returning responses from the storage devices directly to the designated processor via the switch, wherein the switch independently routes the responses from the storage devices to the processor.

51. A system for storing data across a plurality of storage devices, the system comprising:
a plurality of processors, wherein upon receipt of a request for storing data, a processor is designated for handling the request; and
a switch arranged between the processors and the storage devices, wherein the switch independently routes the data to be stored from the designated processor directly to the storage devices, based on directory information created by the processor depending on the data to be stored on the storage devices.

52. A method for storing data across a plurality of storage devices, the method comprising the steps of:
receiving a request for storing data;
designating a processor for handling the request; and
storing data provided by the designated processor on the storage devices via a switch, wherein the switch independently routes the data to be stored directly from the designated processor to the storage devices based on directory information created by the processor depending on the data to be stored.
